(19) United States
(12) Patent Application Publication
(10) Pub. No.: US 2009/0168823 A1
(43) Pub. Date: Jul. 2, 2009

(54) SEMICONDUCTOR LASER DEVICE, OPTICAL PICKUP DEVICE AND OPTICAL INFORMATION RECORDING/REPRODUCING APPARATUS

(76) Inventor: Tomotada Kamei, Osaka (JP)

Correspondence Address: MARK D. SARALINO (PAN);RENNER, OTTO, BOISSELLE & SKLAR, LLP, 1621 EUCLID AVENUE, 19TH FLOOR, CLEVELAND, OH, 44115, US

(21) Appl. No.: 12/300,161

(22) PCT Filed: May 1, 2007
(86) PCT No.: PCT/JP2007/059317

§ 371 Date: Nov. 10, 2008

(30) Foreign Application Priority Data
May 11, 2006 (JP) 2006-132167

(51) Int. Cl. H01S 3/00

(52) U.S. Cl. 372/38.04

(57) ABSTRACT

A semiconductor laser device according to the present invention includes: at least one laser chip that emits a laser beam; a plurality of lead pins that are electrically connected to the laser chip and that supply current to get the laser beam emitted; and a stem that holds the laser chip and the lead pins thereon. The lead pins have mutually different lengths and the longest one of the lead pins is electrically connected to the stem.

### TECHNICAL FIELD

The present invention relates to a semiconductor laser device, and more particularly relates to a semiconductor laser device that can be used effectively in an optical pickup for an optical information read/write apparatus. The present invention also relates to an optical pickup and an optical information read/write apparatus including such a semiconductor laser device.

### BACKGROUND ART

In optical disc technologies, data can be read out from a rotating optical disc by irradiating the disc with a relatively weak light beam with a constant intensity, and detecting the light that has been modulated by, and reflected from, the optical disc.

On a read-only optical disc, information is already stored as pits that are arranged spirally during the manufacturing process of the optical disc. On the other hand, on a rewritable optical disc, a recording material film, from/on which data can be read and written optically, is deposited by an evaporation process, for example, on the surface of a substrate on which tracks with spiral lands or grooves are arranged. In writing data on a rewritable optical disc, data is written there by irradiating the optical disc with a light beam, of which the optical power has been changed according to the data to be written, and locally changing the property of the recording material film.

To read data that is stored on an optical disc or to write data on a rewritable optical disc, the light beam always needs to maintain a predetermined converging state on a target track on an information storage layer. For that purpose, a “focus control” and a “tracking control” need to be done. The “focus control” means controlling the position of an objective lens perpendicularly to the information storage layer (which direction will be referred to herein as a “substrate depth direction”) such that the focus position (or focal point) of the light beam is always located on the information storage layer. On the other hand, the “tracking control” means controlling the position of the objective lens along the radius of a given optical disc (which direction will be referred to herein as a “disc radial direction”) such that the light beam spot is always located right on a target track.

Various types of optical discs such as DVD (digital versatile disc)-ROM, DVD-RAM, DVD-RW, DVD-R, DVD+RW and DVD+R have become more and more popular these days as storage media on which a huge amount of information can be stored at a high density. Meanwhile, CDs (compact discs) are still popular now. And Blu-ray Disc (BD) and other next-generation optical discs that have even higher storage density and even bigger storage capacity than these optical discs have been developed and become increasingly popular nowadays.

The performance of an optical information read/write apparatus for optically reading and/or writing information from/on a storage medium such as an optical disc heavily depends on its optical system. The basic functions an optical pickup unit, which is the core of the optical system, are roughly classifiable into converging light that has been emitted from a light source to form a very small spot to the limit of diffraction, performing focus control and tracking control on the optical system, and detecting and writing a pit signal to read information. These functions can be performed by appropriately combining any of various optical systems and various photoelectric conversion and detection methods according to the purpose and intended application.

A light source is one of essential elements for the optical system. To condense the light to the limit of diffraction, a laser light source is normally used. In an optical pickup unit, a semiconductor laser device of a small size is often used.

As the storage capacities of storage media have been expanded significantly to cope with the increasingly widespread use of optical discs, formats for those optical discs with such high storage densities have been developed one after another, and the very small spot that should be formed to read and write information has further decreased its size lately. In this case, the size of the spot formed by a laser beam is inversely proportional to the numerical aperture (NA) of an objective lens that condenses the laser beam and is proportional to the wavelength of the laser beam. That is why the smaller the spot has become, the shorter the oscillation wavelength of a semiconductor laser device for use in an optical pickup unit should be.

Meanwhile, an information processor compliant with such a new high-density format should also be able to read and write information from/on even conventional media with low storage densities in order to use archived information and resources effectively. That is why an information processor is preferably compliant with multiple different formats.

To cope with those different formats, it is not impossible to provide multiple optical pickup units compliant with those formats for a single information processor. To reduce the size of the apparatus as much as possible, however, a single optical pickup unit should rather include multiple semiconductor laser devices with mutually different wavelengths and a plurality of optical systems and photodetectors that are associated with those laser devices. To further reduce its size, a semiconductor laser device including multiple laser chips in one package has also been used. In such a semiconductor laser device including multiple laser chips in a single package, the greater the number of laser chips included, the greater the number of lead pins to be provided.

Meanwhile, in assembling together a semiconductor laser device and a circuit board that modulates and controls the semiconductor laser device, normally the lead pins of the semiconductor laser device are inserted into, and fixed with soldered to, the fitting holes of the circuit board. That is why in a semiconductor laser device with an increased number of lead pins, it is a time-consuming job that often results in low work efficiency and that would always require a lot of experience and skills to insert those many lead pins accurately into the fitting holes of a circuit board.

A technique for getting that job done more easily by modifying the shape of a semiconductor laser device to a correcting jig is disclosed in Patent Document No. 1. Such a jig is used to correct the shape of lead pins so as to make the pins easily insertable into those fitting holes. Hereinafter, such a technique will be described with reference to FIG. 11.

FIG. 11 is a side view illustrating an assembling process that uses the lead pins of a semiconductor laser device, a circuit board, and a correcting jig.

The semiconductor laser device shown in FIG. 11 includes a laser chip (not shown) that emits a laser beam, a stem 12 that holds the laser chip, and a cap 11 that protects the laser chip. The stem 12 is provided with a number of lead pins 41, 42 and 43 and is electrically connected to the laser chip. Current to cause the laser chip to emit a laser beam is supplied through these lead pins 41, 42 and 43. The cap 11 has a window (not shown) to pass the laser beam emitted.

In FIG. 11, also shown are cross sections of a circuit board 44 and a correcting jig 45. The circuit board 44 has fitting holes 441 through 443 to which the lead pins 41 to 43 are inserted. The correcting jig 45 consists of multiple members that have been separated vertically on the paper so as to sandwich each of the lead pins 41 to 43 between them.

If the lead pin 43 to be corrected is longer than the other lead pins 41 and 42 that need not be corrected, only the lead pin 43 can be pinched with the correcting jig 45. After the positions of only the lead pin 43 have been changed from its initial position indicated by the two-dot chains to an appropriate one such that the pin 43 faces the fitting hole 443 of the circuit board 44, the circuit board 44 is moved in the direction indicated by the arrow Z, thereby inserting the lead pins 41, 42 and 43 into the fitting holes 441, 442 and 443, respectively, fixing the pins 41, 42 and 43 to the holes 441, 442 and 443 with solder and electrically connecting them together. In this case, the relative positions of the lead pins 41 and 42 that are not supposed to be changed should agree with those of the fitting holes 441 and 442.

According to such a technique, however, if the relative positions of the lead pins other than the one that should have its positions changed with the correcting jig 45 disagreed with those of the fitting holes of the circuit board, then those pins could not be inserted into the holes easily and the laser device and the circuit board could not be assembled together smoothly.

Also, as the size of an optical pickup has been reduced, it may be necessary more and more often to attach a circuit board to a semiconductor laser device that has already been built in the optical pickup in advance. In that case, it w ill be difficult to leave sufficient room to move a lead pin correcting jig around the optical pickup.

Meanwhile, a semiconductor device and a light source unit, in which lead pins have mutually different lengths, are disclosed in Patent Documents Nos. 2 and 3.
Patent Document No. 1: Japanese Patent Application Laid-Open Publication No. 2002-344060
Patent Document No. 2: Japanese Patent Application Laid-Open Publication No. 2005-203663
Patent Document No. 3: Japanese Patent Application Laid-Open Publication No. 7-307404

### DISCLOSURE OF INVENTION

### Problems to be Solved by the Invention

The present inventors discovered that if the leads of a semiconductor laser device had mutually different lengths, the semiconductor laser device could certainly be attached to a circuit board easily but would sometimes cause a failure during the assembly process.

In order to overcome the problems described above, the present invention has an object of providing a highly reliable semiconductor laser device that can have its lead pins inserted into a circuit board more easily but that hardly causes a failure and also providing an optical pickup unit and an optical information read/write apparatus including such a semiconductor laser device.

### Means for Solving the Problems

A semiconductor laser device includes: at least one laser chip that emits a laser beam; a plurality of lead pins that are electrically connected to the laser chip and that supply current to get the laser beam emitted; and a stem that holds the laser chip and the lead pins thereon. The lead pins have mutually different lengths and the longest one of the lead pins is electrically connected to the stem.

In one preferred embodiment, the at least one laser chip includes a plurality of laser chips, which emit laser beams with mutually different wavelengths.

In another preferred embodiment, one of the lead pins that is connected to an associated one of the laser chips that emits a laser beam with a relatively short wavelength is shorter than another one of the lead pins that is connected to an associated one of the laser chips that emits a laser beam with a relatively long wavelength.

In still another preferred embodiment, the other lead pins, except the one that is electrically connected to the stem, do not protrude out of a virtual quasi-conical surface that is defined by connecting the tip of the lead pin that is electrically connected to the stem to the outer edge of the stem.

An optical pickup unit according to the present invention includes a semiconductor laser device according to any of the preferred embodiments of the present invention described above.

An optical information read/write apparatus according to the present invention includes the optical pickup unit of the present invention described above.

### EFFECTS OF THE INVENTION

A semiconductor laser device according to the present invention includes a plurality of lead pins with mutually different lengths. That is why even if the relative positions of the lead pins disagree with those of the fitting holes of a circuit board due to a positional tolerance of the fitting holes or deformation of the lead pins, the lead pins can still be inserted into the fitting holes of the circuit board without using a jig or any other member.

In addition, since the longest lead pin is electrically connected to the stem, the influence of static electricity on the semiconductor laser device being mounted on the circuit board can be reduced and failures that could occur during the assembly process can be minimized.

### BRIEF DESCRIPTION OF DRAWINGS

FIG. 1 is an exploded perspective view illustrating an exemplary configuration for a semiconductor laser device according to the present invention.

FIG. 2 is a side view illustrating a configuration for a semiconductor laser device as a first preferred embodiment of the present invention.

FIG. 3A illustrates how to insert the lead pins of the semiconductor laser device of the first preferred embodiment into a circuit board.

FIG. 3B illustrates how to insert the lead pins of the semiconductor laser device of the first preferred embodiment into a circuit board.

FIG. 3C illustrates how to insert the lead pins of the semiconductor laser device of the first preferred embodiment into a circuit board.

FIG. 4 is a side view illustrating a configuration for a semiconductor laser device according to second and third preferred embodiments of the present invention.

FIG. 5 is a circuit diagram illustrating an internal circuit configuration for the semiconductor laser device according to the second and third preferred embodiments of the present invention.

FIG. 6 is a circuit diagram illustrating another internal circuit configuration for the semiconductor laser device as the second preferred embodiment of the present invention.

FIG. 7 is a side view illustrating a configuration for a semiconductor laser device as a fourth preferred embodiment of the present invention.

FIGS. 8(a) and 8(b) illustrate how the semiconductor laser device of the fourth preferred embodiment of the present invention may be left on a plane.

FIG. 9 is a schematic representation illustrating an optical pickup unit as a fifth preferred embodiment of the present invention.

FIGS. 10(a) and 10(b) are schematic representations illustrating an optical information read/write apparatus as a sixth preferred embodiment of the present invention.

FIG. 11 is a side view illustrating an example of a conventional semiconductor laser device.

DESCRIPTION OF REFERENCE NUMERALS

| 1 through 5 | lead pins |
|---|---|
| 11 | cap |
| 12 | stem |
| 14 | circuit board |
| 31 | optical pickup unit |
| 32 | motor |
| 33 | movable flexible printed wiring board |
| 34 | power supply unit |
| 37 | control circuit board |
| 38 | optical disc medium |
| 52, 53, 54, 55 | laser chip |
| 100 | optical information read/write apparatus |
| 102 | sub-mount |
| 103 | heatsink |

### BEST MODE FOR CARRYING OUT THE INVENTION

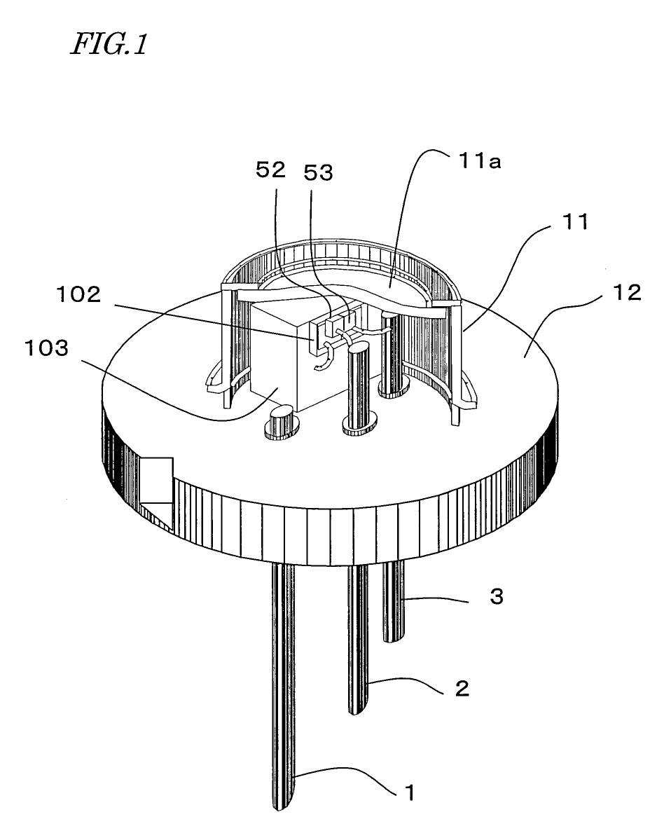

As shown in FIG. 1, an exemplary semiconductor laser device according to the present invention includes laser chips 52 and 53 that emit laser beams, a number of lead pins 1, 2 and 3 that are electrically connected to the laser chips 52 and 53 and that supply current to get the laser beams emitted, and a stem 12 that holds the laser chips 52 and 53 and the lead pins 1, 2 and 3 together. These lead pins 1, 2 and 3 have mutually different lengths and the longest lead pin 1 is electrically connected to the stem 12. As used herein, the “length of a lead pin” means the length of a portion of the lead pin that sticks out of the bottom of the stem 12 and does not include the length of another portion of the lead pin that protrudes into the inside of the cap 11.

In the example illustrated in FIG. 1, the laser chips 52 and 53 are fixed to a heatsink 103 with a sub-mount 102 interposed between them. The laser chips 52 and 53, the sub-mount 102 and the heatsink 103 are shut off from the air by a cap 11 that is secured onto the stem 12 and the inside of the cap 11 is filled with an inert gas such as nitrogen gas. A window member 11a has been fitted in the cap 11 such that the laser beams emitted from the laser chips 52 and 53 go out of the semiconductor laser device through the window member 11a.

The longest lead pin 1 is electrically connected to the stem 12, while the other lead pins 2 and 3 are electrically connected to the respective n-side electrodes (not shown) of the laser chips 52 and 53. On the other hand, the p-side electrodes (not shown, either) of the laser chips 52 and 53 are electrically connected to the lead pin 1. When drive current is supplied to the laser chip 52, the laser chip 52 emits a laser beam (such as an infrared laser beam). Likewise, when drive current is supplied to the laser chip 53, the laser chip 53 emits a laser beam (such as an infrared laser beam). The laser chips 52 and 53 are designed so as to emit laser beams with mutually different wavelengths. Such laser chips with different oscillation wavelengths are normally fabricated by forming two different types of semiconductor multilayer structures on two different semiconductor wafers, and therefore, are implemented as two separate chips in this example. However, these laser chips could also be integrated together into a single chip by forming two different types of semiconductor multilayer structures on the same semiconductor wafer.

In the example illustrated in FIG. 1, the number of laser chips arranged is two. However, as will be described later, the semiconductor laser device of the present invention may include three or more laser chips. In any case, what counts most in the present invention is that the lead pins should have mutually different lengths and that the longest lead pin should be electrically connected to the stem. That is why the semiconductor laser device of the present invention may include an additional photosensitive element such as a photodetector or an additional optical element such as a hologram other than the laser chips. If the semiconductor laser device includes a photosensitive element, however, at least one of three or more lead pins should be electrically connected to the photosensitive element.

### Embodiment 1

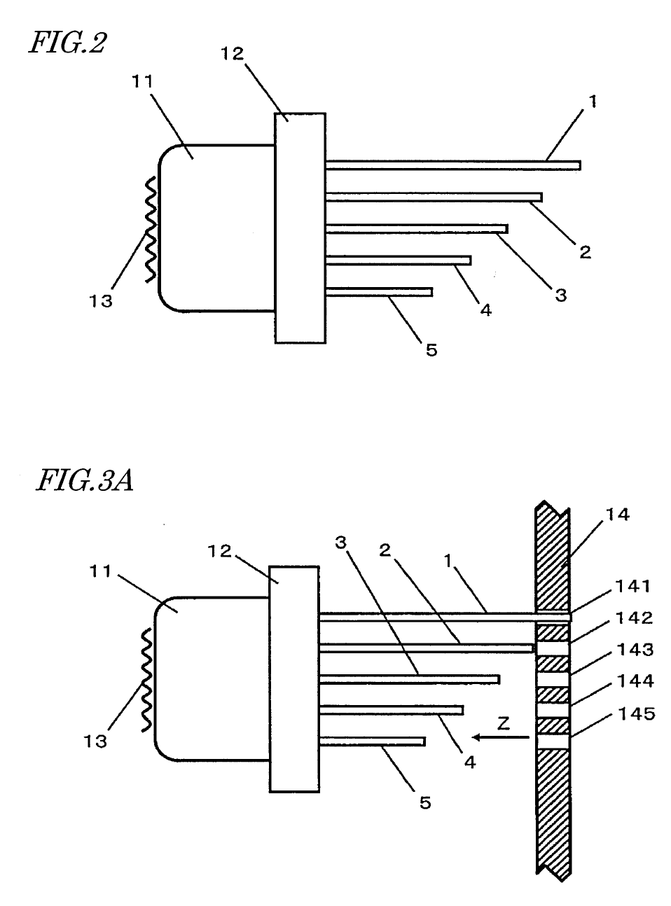

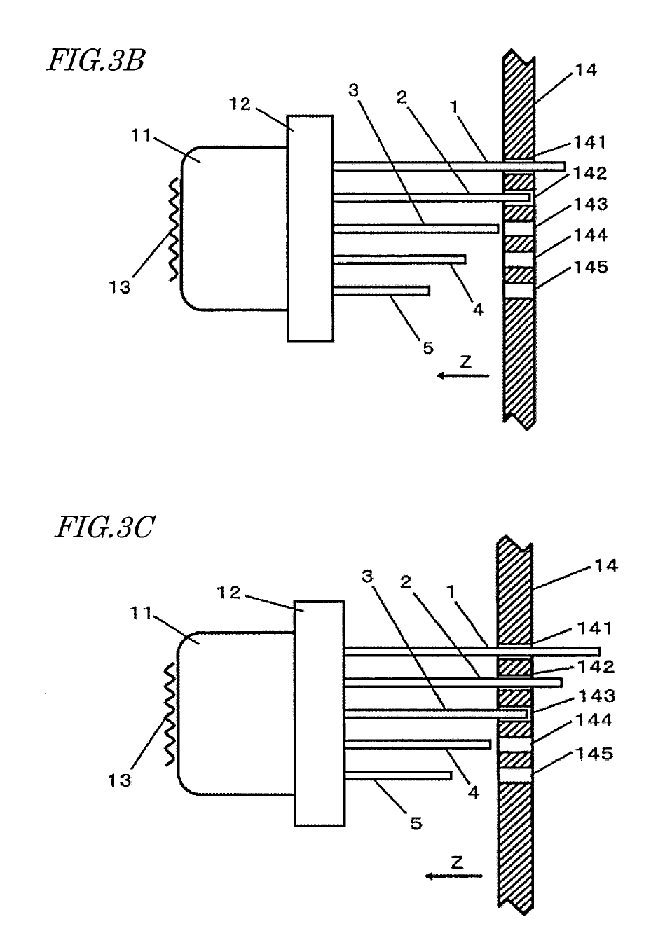

Hereinafter, a First Preferred Embodiment of a semiconductor laser device according to the present invention will be described in detail with reference to FIGS. 2, 3A, 3B and 3C.

First, look at FIG. 2, which is a side view illustrating a schematic configuration for a semiconductor laser device as a first preferred embodiment of the present invention.

The semiconductor laser device of this preferred embodiment includes four laser chips (not shown), lead pins 1 through 5 for supplying current to the laser chips, a cap 11 that protects the laser chips, and a stem 12 secured to the cap 11. A window member (not shown) is fitted in one surface 13 of the cap 11 to transmit the laser beams that have been emitted from the laser chips.

As shown in FIG. 2, the lead pins 1 through 5 have mutually different lengths. If the longest lead pin 1 has a length of 10 mm, for example, then the other lead pins 2, 3, 4 and 5 may have lengths of 9 mm, 8 mm, 7 mm and 6 mm, respectively. The longest lead pin 1 is electrically connected to the stem 12.

Next, the process step of inserting the lead pins 1 through 5 of the semiconductor laser device of this preferred embodiment into the circuit board 14 will be described with reference to FIGS. 3A through 3C.

The circuit board 14 for use in this preferred embodiment includes a wiring pattern for supplying drive current to the semiconductor laser device and a number of fitting holes 141 through 145 that run through the circuit board 14. The arrangement of the fitting holes 141 through 145 corresponds with that of the lead pins 1 through 5 in the semiconductor laser device.

By inserting the lead pins 1 through 5 into the respective fitting holes 141 through 145 and then fixing them together with solder, the semiconductor laser device is fixed onto the circuit board 14. As a result, a desired amount of current can be supplied to any arbitrary one of the lead pins 1 through 5.

To mount the semiconductor laser device of this preferred embodiment onto the circuit board 14, the five lead pins 1 through 5 need to be inserted into the respective fitting holes 141 through 145 of the circuit board 14 as described above. However, if the relative positions of the lead pins 1 through 5 disagree with those of the fitting holes 141 through 145 of the circuit board 14 due to the deformation of the lead pins 1 through 5 or a positional tolerance of the fitting holes 141 through 145, it is difficult to insert the lead pins 1 through 5 into the fitting holes 141 through 145 just as intended.

Supposing the lengths of the lead pins 1 through 5 are identified by L1, L2, L3, L4 and L5, respectively, the respective lengths of the lead pins are defined according to this preferred embodiment so as to satisfy the inequality L1>L2>L3>L4>L5. That is why in inserting the lead pins 1 through 5 of the semiconductor laser device into the circuit board 14, the longest lead pin 1 with the greatest length L1 is inserted into the fitting hole 141 of the circuit board 14 earlier than any other pin as shown in FIG. 3A.

As the circuit board 14 is further moved in the direction indicated by the arrow Z in FIG. 3A, the second longest lead pin 2 with the length L2 is inserted into the fitting hole 142 next. In this case, even if the position of the tip of the lead pin 2 disagrees to a certain degree with that of the fitting hole 142 due to some deformation of the lead pin or some positional tolerance of the fitting hole, the lead pin 2 can be still be inserted into the fitting hole 142 such that only the pin 2 is aligned with the hole 142 by shifting the circuit board 14 parallel to its principal surface and changing the positions of the hole 142. As a result, the state shown in FIG. 3B is realized easily. When the positions of the hole 142 are changed, the lead pin 1 has already been inserted into the fitting hole 141 of the circuit board 14. That is why even if the circuit board 14 is shifted, the lead pin 1 will be deformed and keep up with the movement of the circuit board 14 and will not come out of the circuit board 14. Meanwhile, the lead pins 3 to 5 are shorter than the lead pin 2, and therefore, have nothing to do with the shift of the circuit board 14.

And as the circuit board 14 is further moved in the direction Z, the third longest lead pin 3 with the length L3 is inserted into the fitting hole 143 next. In this case, even if the position of the tip of the lead pin 3 disagrees to a certain degree with that of the fitting hole 143 due to some deformation of the lead pin or some positional tolerance of the fitting hole as in inserting the lead pin 2, the lead pin 3 can be still be inserted into the fitting hole 143 such that only the pin 3 is aligned with the hole 143 by shifting the circuit board 14 parallel to its principal surface and changing the positions of the hole 143. As a result, the state shown in FIG. 3C is realized easily. When the positions of the hole 143 are changed, the lead pins 1 and 2 have already been inserted into the respective fitting holes 141 and 142 of the circuit board 14. That is why even if the circuit board 14 is shifted, the lead pins 1 and 2 will be just deformed and will not come out of the circuit board 14. Meanwhile, the lead pins 4 and 5 are shorter than the lead pin 3, and therefore, have nothing to do with the shift of the circuit board 14.

After that, the same work will get done on the other lead pins 4 and 5, too. In this manner, even if the relative positions of the lead pins disagree with those of the fitting holes of the circuit board 14 due to a positional tolerance of the fitting holes or deformation of the lead pins in a semiconductor laser device provided with multiple lead pins for multiple laser beams emitted, the lead pins can still be inserted into the fitting holes of the circuit board easily without using a special type of correcting jig or any other member.

It should be noted that the difference in length between any two of the lead pins 1 through 5 is preferably approximately equal to or greater than the thickness of the circuit board 14 (e.g., in the range of 0.2 mm to 1.0 mm). In that case, it is not until one of the lead pins has been inserted into the circuit board 14, has its tip sticking out of the other side of the circuit board 14 opposite to the stem 12, and allows the person who makes this device to confirm its inserted position easily with the eyes that the next pin can be inserted. As a result, a number of lead pins can be inserted into the fitting holes more easily.

In the preferred embodiment described above, the number of lead pins is supposed to be five. However, any other number of lead pins may be inserted.

Also, in the preferred embodiment described above, the lead pins are supposed to be arranged in the order of length such that the longest pin comes first and then is followed by the second longest one. However, as long as the lead pins have mutually different lengths, the lead pins may be arranged in any other order. Also, those lead pins may be arranged in line, in a circle or even concentrically on the stem. That is to say, their arrangement pattern is arbitrary.

Furthermore, the circuit board 14 of this preferred embodiment may be either a hard circuit board mainly made of glass epoxy or phenol resin or a flexible printed wiring board including polyimide or any other suitable material as its main ingredient.

### Embodiment 2

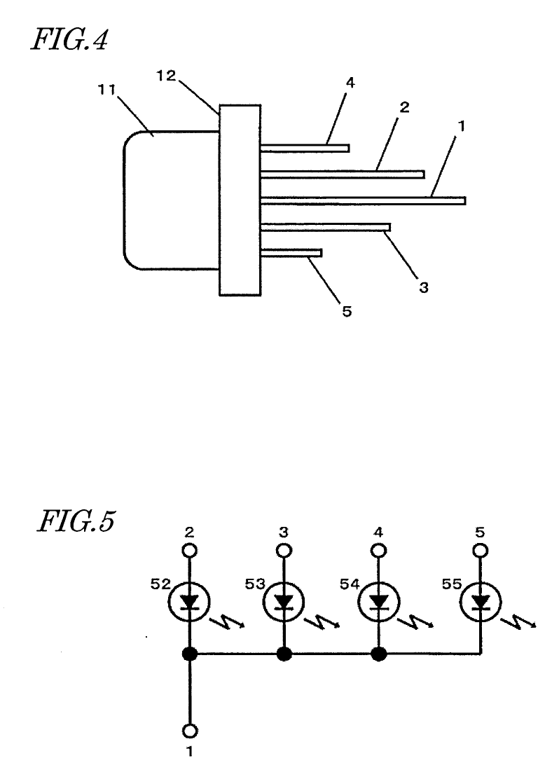

Hereinafter, a second preferred embodiment of a semiconductor laser device according to the present invention will be described with reference to FIGS. 4 through 6. FIG. 4 is a side view illustrating a configuration for a semiconductor laser device according to the second preferred embodiments of the present invention. FIG. 5 is a circuit diagram illustrating an internal circuit configuration for the semiconductor laser device of the second preferred embodiment. And FIG. 6 is a circuit diagram illustrating another internal circuit configuration for the semiconductor laser device of the second preferred embodiment. In FIGS. 4 and 5, any component also shown in FIG. 2 and having substantially the same function as its counterpart is identified by the same reference numeral and the description thereof will be omitted herein to avoid redundancies.

In the circuit diagram shown in FIG. 5, the terminals identified by the reference numerals 1 through 5 respectively correspond to the lead pins 1 through 5 shown in FIG. 4. In this preferred embodiment, four laser chips 52 through 55 with mutually different oscillation wavelengths are electrically connected to the lead pins 1 through 5. More specifically, the lead pins 2 through 5 are connected to the respective anodes (i.e., p-side electrodes) of the laser chips 52 through 55. Meanwhile, the cathodes (i.e., n-side electrodes) of all of these laser chips 52 through 55 are connected in common to the lead pin 1. Furthermore, the lead pin 1 is held by, and electrically connected to, the stem 12 made of a conductor.

In this preferred embodiment, the lead pins 1 through 5 also have mutually different lengths as shown in FIG. 4. And supposing their lengths are identified by L1, L2, L3, L4 and L5, respectively, those lengths are defined so as to satisfy the inequality L1>L2>L3>L4>L5, too.

Hereinafter, it will be described how to mount this semiconductor laser device onto the circuit board.

In the semiconductor laser device of this preferred embodiment, the cap 11 or stem 12 thereof is held by some holding mechanism (not shown) such as a jig, a pair of tweezers or the base of an optical pickup. However, if either this holding mechanism or the circuit board were charged with static electricity and had mutually different potential levels, the static electricity would flow through the lead pins being inserted into the fitting holes of the circuit board when the lead pins contact with the circuit board. In that case, the laser chips might get damaged.

According to this preferred embodiment, however, in inserting the lead pins of the semiconductor laser device into the circuit board, the longest one 1 gets inserted into the circuit board first as in the first preferred embodiment described above. In addition, since the lead pin 1 is connected to the stem 12 of the package, the static electricity will flow through only the lead pin 1, not through any of the lead pins 2 to 5 that are out of contact with the circuit board. As a result, no current will flow through any of the laser chips 52 through 55 even when there is static electricity. And when the lead pins 2 through 5 are connected sequentially after that, the influence of the static electricity will have already waned, thus doing very little damage on the laser chips 52 through 55. As a result, a highly reliable semiconductor laser device can be provided.

In the preferred embodiment described above, the number of lead pins is supposed to be five. However, any other number of lead pins may be arranged as well.

Also, in the preferred embodiment described above, the lead pin 1 that is electrically connected to the stem 12 is connected to the respective cathodes of the laser chips 52 through 55. However, the lead pin 1 may also be connected to either the respective anodes of the laser chips 52 through 55 or some combination of anodes and cathodes thereof.

Furthermore, the lead pins do not have to be arranged as shown in FIG. 5. For example, a circuit configuration such as the one shown in FIG. 6 may also be adopted. In the example illustrated in FIG. 6, the laser chip 54 forms a circuit between the lead pins 4 and 5 and has no common terminal. Nevertheless, since the longest lead pin 1 is still connected to the stem 12, no damage will be done on the laser chip 54 even under static electricity.

### Embodiment 3

Hereinafter, a third preferred embodiment of a semiconductor laser device according to the present invention will be described. The appearance and circuit configuration of the semiconductor laser device of the third preferred embodiment are just as shown in FIGS. 4 and 5 that were already referred to when the second preferred embodiment of the present invention was described.

The only difference between the semiconductor laser device of this preferred embodiment and the counterpart of the second preferred embodiment described above lies in that the device of the third preferred embodiment satisfies the inequality λ52>λ53>λ54>λ55, where λ52, λ53, λ54 and λ55 represent the oscillation wavelengths of the laser chips 52, 53, 54 and 55, respectively. That is to say, the longer the lead pin, the longer the wavelength of the laser chip, to which that pin is connected. In other words, the shorter the lead pin, the shorter the wavelength of the laser chip, to which that lead pin is connected. Thus, in this preferred embodiment, the length of a lead pin represents how long the wavelength of its associated laser chip, to which that lead pin is connected, is.

A person who is handling the semiconductor laser device of this preferred embodiment can see intuitively which lead pin should be connected to which laser chip not just by the arrangement of the pins but also the lengths thereof. That is why even in a situation where lead wires are directly connected to the lead pins, connection errors can be avoided. As a result, a highly reliable semiconductor laser device can be provided without doing any damage on laser chips.

### Embodiment 4

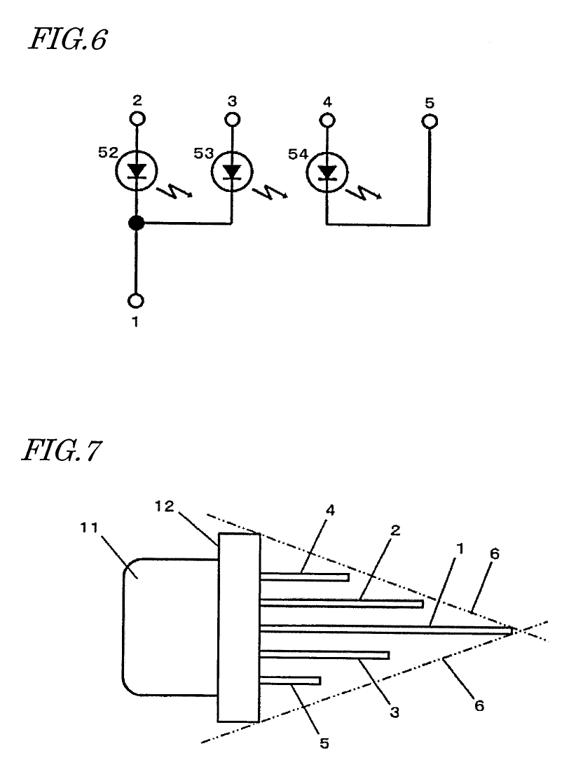

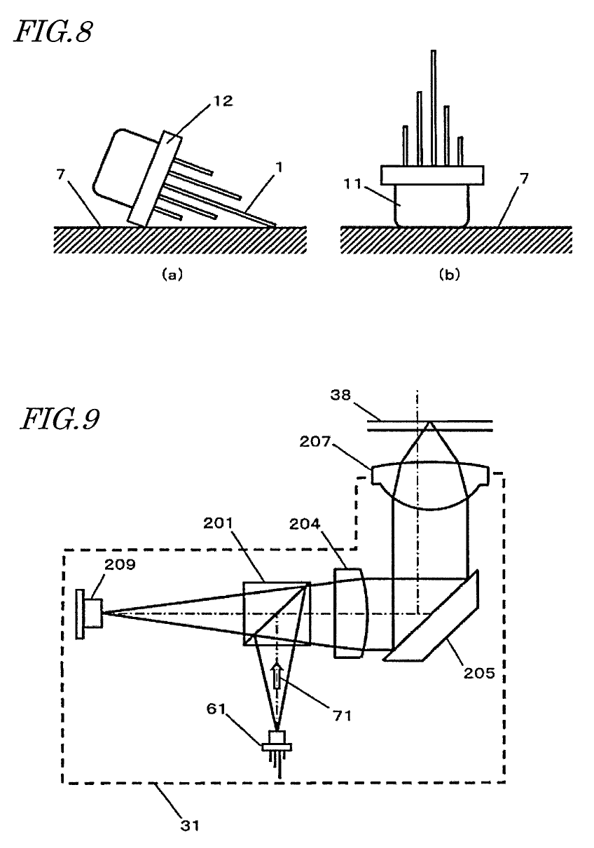

Hereinafter, a fourth preferred embodiment of a semiconductor laser device according to the present invention will be described with reference to FIGS. 7 and 8. FIG. 7 is a side view illustrating a configuration for a semiconductor laser device as a fourth preferred embodiment of the present invention. FIG. 8 illustrates how the semiconductor laser device of the fourth preferred embodiment may be left on a plane. In FIGS. 7 and 8, any component also shown in FIG. 4 and having substantially the same function as its counterpart is identified by the same reference numeral and the description thereof will be omitted herein to avoid redundancies. The semiconductor laser device of this preferred embodiment has the same electrical configuration as the counterpart of the second preferred embodiment shown in FIG. 5.

In FIG. 7, the two-dot chains 6 indicate a conical surface that is defined by the tip of the longest lead pin 1 and the edge of the stem 12. The longest lead pin 1 is preferably arranged approximately at the center of the stem 12. In this preferred embodiment, the other lead pins 2 through 5 are arranged so as to be located inside of this conical surface 6. That is why even if the person who is handling this semiconductor laser device puts it on a plane such as the table surface or the floor, only the tip of the lead pin 1 and the stem 12, which are electrically connected together and are at the same potential level, contact with the plane 7 as shown in FIG. 8(a). For that reason, even if the plane 7 is charged with static electricity, the internal semiconductor chips are unlikely to be damaged. Consequently, even if the person who is handling this semiconductor laser device during the manufacturing process of optical pickups put it on the table as it is or dropped it to the floor accidentally, the chances of damaging the semiconductor chips with static electricity should be very slim. As a result, a highly reliable semiconductor laser device can be provided.

Naturally, if the semiconductor laser device is dropped, the cap 11 may contact with the plane 7 as shown in FIG. 8(b). In that case, however, little damage will be done by static electricity, irrespective of the length of the lead pin 1.

The lead pins 1 through 5 may be arranged in line so as to be included within the same plane or may also be arranged in any other pattern. What counts most in this preferred embodiment is that the space defined by the tip of the longest lead pin and the outer edge of the stem 12 needs to house all of the other lead pins. It should be noted that the projection shape of the stem 12, which is defined on a plane that intersects with the lead pin 1 at right angles, does not have to be circular but could also be rectangular, any other polygonal shape or even elliptical.

### Embodiment 5

Hereinafter, a preferred embodiment of an optical pickup unit according to the present invention will be described with reference to FIG. 9, which is a schematic representation illustrating an optical pickup unit as a fifth preferred embodiment of the present invention.

The optical pickup unit of this preferred embodiment is characterized by including a semiconductor laser device 61 having the same configuration as the counterpart of any of the first through fourth preferred embodiments described above. This semiconductor laser device emits light at the three wavelengths of 405 nm, 650 nm and 790 nm, for example, in response to the current supplied by a driver circuit (not shown).

The laser beam 71 emitted from the semiconductor laser device 61 is transmitted through a beam splitter 201, a condenser lens 204, and a reflecting mirror 205 and then incident on an objective lens 207, which converges the laser beam 71 onto an optical disc 38.

The laser beam 71 reflected from the optical disc 38 is transmitted through the objective lens 207, the reflecting mirror 205 and the condenser lens 204 and then incident on the beam splitter 201, which has the function of separating the returning laser beam 71 that has been reflected from the optical disc 38 and guiding it toward a photodetector 209. In FIG. 9, the dashed line indicates the range of the optical pickup unit.

The photodetector 209 carries out photoelectric conversion on the incoming laser beam 71, thereby outputting an electrical signal representing the laser beam 71. The output electrical signal of the photodetector 209 is used as an RF signal representing a sequence of pits on the optical disc 38 or a servo signal to trace the pit sequence.

In writing data on the optical disc 38, the power of the laser beam emitted from the semiconductor laser device 61 is higher than in reading data from the optical disc 38.

The semiconductor laser device 61 selectively emits a laser beam having a wavelength that is associated with the format of the optical disc 38, from/on which information is going to be read or written. The optical pickup unit of this preferred embodiment may be provided with multiple sets of optical members for the respective wavelengths. Alternatively, at least some of those optical members may be used in common to transmit or reflect laser beams with multiple different wavelengths.

The optical pickup unit of this preferred embodiment includes a semiconductor laser device according to the present invention, and therefore, an electrical wiring circuit board can be easily attached to the semiconductor laser device and damage that could be done by static electricity can be reduced. In addition, even when lead wires are directly connected to the lead pins, connection errors can be avoided. Or even if the person who is assembling the optical pickup unit puts the semiconductor laser device on the table or drops it to the floor accidentally, the damage can also be minimized. As a result, a highly reliable semiconductor laser device can be provided at a low cost.

### Embodiment 6

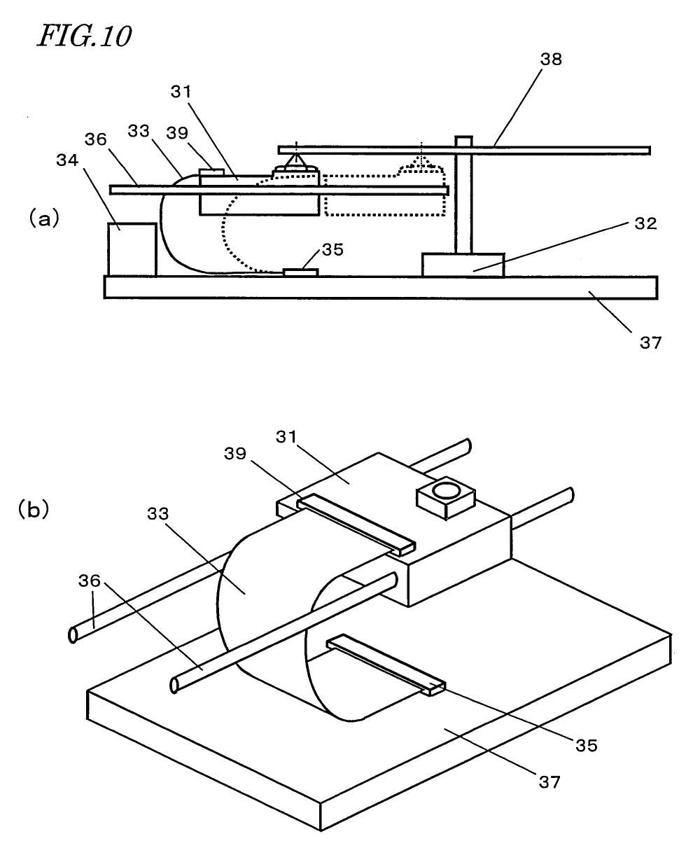

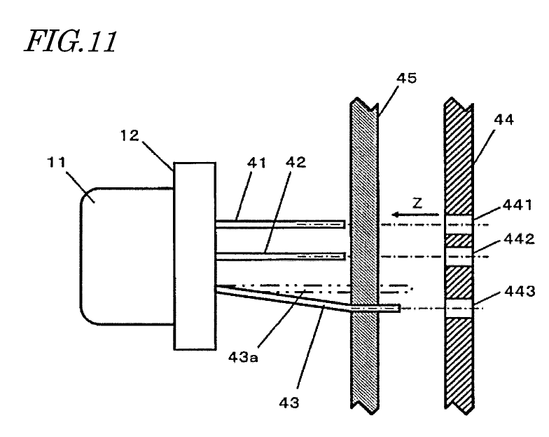

Hereinafter, a sixth preferred embodiment of the present invention will be described with reference to FIG. 10. Specifically, FIG. 10(a) is a schematic representation illustrating an optical information read/write apparatus as a sixth preferred embodiment of the present invention and FIG. 10(b) is a perspective view thereof.

The optical information read/write apparatus shown in FIG. 10 includes an optical pickup unit 31, a motor 302 for supporting and rotating an optical disc medium 38, a control circuit board 37 for controlling the operation of the optical pickup unit 31, a movable flexible printed wiring board 33 that electrically connects the optical pickup unit 31 and the control circuit board 37 together, a power supply unit 34 for supplying electric power to the control circuit board 37, and a guide shaft 36 that supports the optical pickup unit 31.

The optical pickup unit 31 has the same configuration as the counterpart of the fifth preferred embodiment described above. The optical pickup unit 31 has a connector 39 to which the movable flexible printed wiring board 33 is supposed to be connected. And the control circuit board 37 also has a connector 35 to which the movable flexible printed wiring board 33 is supposed to be connected.

Hereinafter, the basic operation of this optical information read/write apparatus will be described.

When loaded into this optical information read/write apparatus, the optical disc medium 38 starts to be rotated by the motor 32. The optical pickup unit 31 sends a signal representing its position with respect to the optical disc medium 38 to the control circuit board 37. In response, the control circuit board 37 performs computations on that signal, thereby outputting a signal for moving the optical pickup unit 31 along the guide shaft 36 substantially in the radial direction and a signal for subtly moving the objective lens (not shown) in the optical pickup unit 31 to a transport mechanism (not shown). As a result, a focus servo control and a tracking servo control are performed on the optical disc medium 38 and data is read from, written on, or erased from, the optical disc medium 38. The power supply unit 34 supplies electric power to the control circuit board 37, the optical pickup unit 31, the motor 32 and a drive mechanism (not shown) for the optical pickup unit 31. Optionally, a connection terminal to the power supply or an external power supply may be provided for each driver circuit.

The optical information read/write apparatus of this preferred embodiment includes the optical pickup unit 31 of the present invention. Thus, a highly reliable optical information read/write apparatus can be provided at a low cost.

As described above, a semiconductor laser device according to the present invention is designed such that the longest one of multiple lead pins thereof is electrically connected to the stem. That is why when mounted onto a circuit board, the semiconductor laser device is affected by static electricity to a much lesser degree. As a result, a highly reliable semiconductor laser device can be provided.

Also, in a preferred embodiment of the present invention in which lead pins to be connected to multiple laser chips that emit laser beams with relatively short wavelengths have their physical lengths defined proportionally to that of another lead pin to be connected to another laser chip that emits a laser beam with a relatively long wavelength, the person who handles the semiconductor laser device can see intuitively which lead pin should be connected to which laser chip. As a result, in a situation where lead wires are directly connected to lead pins, connection errors can be avoided and a highly reliable semiconductor laser device can be provided without doing any damage on the laser chips.

Also, in another preferred embodiment of the present invention in which the lead pins other than the one that is electrically connected to the stem are arranged so as not to protrude out of a virtual quasi-conical surface that is defined by the tip of that lead pin that is electrically connected to the package and the outer edge of the stem, even when left on a table or dropped onto a floor accidentally, the semiconductor laser device is unlikely to be damaged due to static electricity. As a result, a highly reliable semiconductor laser device can be provided.

Furthermore, according to the present invention, the semiconductor laser device can be easily mounted onto an electric wiring circuit board during the assembly process of the optical pickup and is very unlikely to be damaged due to static electricity, thus providing a highly reliable optical pickup unit at a low cost.

### INDUSTRIAL APPLICABILITY

A semiconductor laser device according to the present invention includes the longest lead pin to be electrically connected to a stem and a number of other lead pins with mutually different lengths, and therefore, can be mounted onto a circuit board easily with the influence of static electricity minimized. Consequently, the present invention can be used effectively in optical pickups, optical information read/write apparatuses, optical disc drives and various other apparatuses that use a semiconductor laser device.

1. A semiconductor laser device comprising:
at least one laser chip that emits a laser beam;
a plurality of lead pins that are electrically connected to the laser chip and that supply current to get the laser beam emitted; and
a stem that holds the laser chip and the lead pins thereon,
wherein the lead pins have mutually different lengths and the longest one of the lead pins is electrically connected to the stem.

2. The semiconductor laser device of claim 1, wherein the at least one laser chip includes a plurality of laser chips, which emit laser beams with mutually different wavelengths.

3. The semiconductor laser device of claim 2, wherein one of the lead pins that is connected to an associated one of the laser chips that emits a laser beam with a relatively short wavelength is shorter than another one of the lead pins that is connected to an associated one of the laser chips that emits a laser beam with a relatively long wavelength.

4. The semiconductor laser device of claim 2, wherein the other lead pins, except the one that is electrically connected to the stem, do not protrude out of a virtual quasi-conical surface that is defined by connecting the tip of the lead pin that is electrically connected to the stem to the outer edge of the stem.

5. An optical pickup unit comprising the semiconductor laser device of claim 1.

6. An optical information read/write apparatus comprising the optical pickup unit of claim 5.
